(19) United States
(12) Patent Application Publication
(10) Pub. No.: US 2020/0258316 A1
(43) Pub. Date: Aug. 13, 2020

(54) METHOD OF GARBLING REAL-WORLD IMAGE FOR SEE-THROUGH HEAD MOUNT DISPLAY AND SEE-THROUGH HEAD MOUNT DISPLAY WITH REALWORLD IMAGE GARBLING FUNCTION

(71) Applicant: PSYCURE Co., Ltd., Seoul (KR)

(72) Inventor: Joong Ho LEE, Gyeonggi-do (KR)

(21) Appl. No.: 16/789,475

(22) Filed: Feb. 13, 2020

(30) Foreign Application Priority Data
Feb. 13, 2019 (KR) 10-2019-0016940
Feb. 13, 2019 (KR) 10-2019-0016942

(51) Int. Cl. G06T 19/20; G06T 19/00; G06F 3/01

(52) U.S. Cl. CPC G06T 19/20; G06T 2219/2024; G06F 3/011; G06T 19/006

(57) ABSTRACT

A method of garbling a real-world image for a see-through head mounted display includes capturing a real-world image through a see-through camera; converting the captured real-world image into a video signal; changing reality of the real-world image by garbling the real-world image converted into the video signal; and receiving the garbled real-world image and driving the see-through head mounted display to display the received garbled real-world image.

### CROSS-REFERENCE TO RELATED APPLICATION

This application claims priority on Korean Patent Application Nos. 10-2019-0016940 and 10-2019-0016942, both filed on Feb. 13, 2019, the contents of which are incorporated herein by reference.

### BACKGROUND OF THE INVENTION

### Field of the Invention

The present invention relates to a video see-through head mounted display (HMD) for garbling and outputting a see-through image in real time for the purpose of changing reality, and particularly to a method of garbling a real-world image for a see-through HMD and a see-through HMD with a real-world image garbling function, in which a reality changing unit including an image garbling unit for garbling see-through audiovisual information and a garbling control unit for controlling the image garbling unit is incorporated. The present invention also relates to a method of garbling a real-world image for a direct encoding type see-through HMD and a direct encoding type see-through HMD with a real-world image garbling function.

### Description of Related Art

Head mounted displays (HMDs) are wearable display devices mounted on a head, and are variously called a virtual reality (VR) headset, VR glasses, smart glasses, smart eyewear, smart goggles, VR goggles, and the like. They are all common in that they are wearable display devices mounted on a user's face, and their names are subdivided in accordance with ways of wearing, components, forms and functions, but all of these devices can be represented by the term HMD.

An advantage of a see-through HMD is, firstly, that it is one of the devices that can realize augmented reality. Augmented reality is a technology that provides spatial integration of the real-world with virtual objects or digital information and provides a visual experience in which the real-world and a virtual world are connected to each other.

Secondly, information not visible to the naked eye, for example, infrared rays, ultraviolet rays, ultrasonic waves, electromagnetic waves, and the like, may be provided to the user's eyes in real time using the see-through HMD equipped with a special camera. In addition, the camera's zoom-in function allows you to zoom in on a distant object several times to tens of times. If a fisheye lens is mounted on the HMD, it can be utilized as a means of transcending visual ability, such as having a wide field of view.

Thirdly, the see-through HMD wearable display devices can store the front view that the user is watching as it is seen. The stored video information can be shared with others through a network, and the user can watch it in the future. The see-through HMD enables the user to share visual experiences that go beyond constraints of time and space.

Finally, the see-through HMD also provides a function of protecting the user's eyes from risks of damaging the eyes such as sunlight, laser, dirt, and harmful substances.

Korean Patent Application Publication No. 1020140178710 (titled “see-through type head mounted display”) published on Dec. 11, 2014 discloses a see-through HMD including an optical combiner, a virtual image display element for projecting a virtual image onto the optical combiner, and a shade cover disposed on a front surface of the optical combiner, in which the shade cover includes a first transparent electrode, an electrolytic layer disposed on the first transparent electrode, an electrochromic layer that is disposed on the electrolytic layer and contains an electrochromic material, and a second transparent electrode disposed on the electrochromic layer. According to the conventional technique, by adopting embodiments of the shade cover, excellent visibility of a virtual image can be secured without amplifying brightness of the virtual image even if illuminance of an actual environment increases.

However, the see-through HMD according to the conventional technique has the following disadvantages. That is, since the see-through HMD converts the real-world into a video image to show it via a digital display, the user feels unfamiliar with the visual feeling of the real-world. This is because a digitally converted video signal is heterogeneous no matter how much it is expressed in the same way as the real vision. This heterogeneity of vision is a characteristic and fundamental problem of the see-through HMD. Typically, this heterogeneity is considered to be a disadvantage because it lowers visual ability such as vision, viewing angle, color separation. Therefore, various technologies such as increasing display resolution, increasing viewing angles, improving performance of a see-through camera, and improving image quality have been attempted to overcome garbling of the real vision. However, this heterogeneity makes the user feel a visual confusion as if the real-world is a virtual world, and can expect an effect of lowering a psychological burden such as tension and fear in the real-world.

On the other hand, the see-through HMD requires many steps of encoding to output the real-world image as display information via predetermined manipulation processes after converting the real-world image into digital information. There is a delay in each process, and the user eventually sees the delayed real-world. This causes problems such as motion sickness and poor work ability, and short delays can even cause big accidents when driving or exercising.

Therefore, a technology that can provide a visual confusion effect generated in the see-through HMD in various forms in accordance with situations while minimizing a video delay is eagerly required.

### PATENT DOCUMENTS

[Patent Document 1] Korean Patent Application Publication No. 1020140178710 (published on Dec. 11, 2014 and titled “see-through type head mounted display”)

### SUMMARY OF THE INVENTION

An object of the present invention is to provide a method of garbling a real-world image for a see-through head mounted display and a direct encoding type see-through head mounted display, which is distinguished from existing augmented reality techniques for matching virtual information to a real-world image and is distinguished from correction techniques for improving image quality of a see-through image.

Also, an object of the present invention is to provide a see-through head mounted display and a direct encoding type see-through head mounted display that have a real-world image garbling function, in which a reality changing unit is embedded in a see-through HMD so that effects such as psychotherapy and psychological stability of a user can be provided.

Also, an object of the present invention is to provide a direct encoding type see-through head mounted display in which a video delay between a real-world image and a displayed image can be minimized.

An aspect of the present invention for achieving the above objects is a method of garbling a real-world image for a see-through head mounted display, including steps of: capturing a real-world image through a see-through camera; converting the captured real-world image into a video signal; changing reality of the real-world image by garbling the real-world image converted into the video signal; and receiving the garbled real-world image and driving the see-through head mounted display to display the received garbled real-world image. The step of capturing the real-world image includes s step of capturing the real-world image in accordance with a mobile industry processor interface (MIPI) camera serial interface (CSI) standard, and the step of converting the captured real-world image into a video signal includes a step of converting a MIPI CSI signal into a format selected from the group consisting of NTSC, PAL, RGB, YCbCr, HDMI, MPEG, AVI, VOB, and H.264. The step of changing reality of the real-world image includes steps of: determining a garbling applied to the real-world image; and garbling the real-world image on the basis of the determined garbling. The step of determining a garbling includes at least one of: determining the garbling on the basis of a command received from a user; determining a psychological state of the user on the basis of a sensor signal obtained from a sensor that observes a physical state of the user and determining the garbling on the basis of the determined psychological state; and determining the user's behavior on the basis of a sensor signal obtained from a sensor that observes the user's behavior and determining the garbling on the basis of the determined behavior. The sensor that observes the user's physical state includes a sensor for detecting a physiological signal of the user including at least one of skin color, pulse rate, blood pressure, electrocardiogram, skin conductivity, electromyogram, and perspiration, and the sensor that observes the user's behavior includes at least one of a position sensor, a GPS sensor, a speed sensor, and an acceleration sensor. The step of garbling the real-world image includes at least one of: changing a pixel value of the real-world image; performing cartoon rendering that applies a 3D image technique to the real-world image to give a feeling like a cartoon; changing a contrast of the real-world image; binarizing the real-world image to perform black and white image processing; changing an expression of a specific object included in the real-world image; adjusting brightness or darkness of the real-world image; and changing at least one of frequency, amplitude, and pitch of sound collected with the real-world image. The step of driving the see-through head mounted display includes a step of converting the received garbled real-world image into a MIPI display serial interface (DSI) format compatible with the see-through head mounted display and providing the result to a driving unit of the see-through head mounted display.

Also, an aspect of the present invention for achieving the above objects is a see-through head mounted display having a real-world image garbling function, including: a see-through camera which captures a real-world image; a digital converting unit which converts the captured real-world image into a video signal; a reality changing unit which changes reality of the real-world image by garbling the real-world image converted into the video signal; and a display driving unit which receives the garbled real-world image and drives the see-through head mounted display to display the received garbled real-world image. The see-through camera captures the real-world image in accordance with a MIPI CSI standard, and the digital converting unit converts a MIPI CSI signal into a format selected from the group consisting of NTSC, PAL, RGB, YCbCr, HDMI, MPEG, AVI, VOB, and H.264. The reality changing unit includes: a garbling control unit which determines the garbling applied to the real-world image; and an image garbling unit which garbles the real-world image on the basis of the determined garbling. The garbling control unit is configured to perform at least one of: determining the garbling on the basis of a command received from a user; determining a psychological state of the user on the basis of a sensor signal obtained from a sensor that observes a physical state of the user and determining the garbling on the basis of the determined psychological state; and determining the user's behavior on the basis of a sensor signal obtained from a sensor that observes the user's behavior and determining the garbling on the basis of the determined behavior. The sensor that observes the user's physical state includes a sensor for detecting a physiological signal of the user including at least one of skin color, pulse rate, blood pressure, electrocardiogram, skin conductivity, electromyogram, and perspiration, and the sensor that observes the user's behavior includes at least one of a position sensor, a GPS sensor, a speed sensor, and an acceleration sensor. The image garbling unit is configured to perform at least one of: changing a pixel value of the real-world image; performing cartoon rendering that applies a 3D image technique to the real-world image to give a feeling like a cartoon; changing a contrast of the real-world image; binarizing the real-world image to perform black and white image processing; changing an expression of a specific object included in the real-world image; adjusting brightness or darkness of the real-world image; and changing at least one of frequency, amplitude, and pitch of sound collected with the real-world image. The display driving unit is configured to convert the received garbled real-world image into a MIPI DSI format compatible with the see-through head mounted display to drive the see-through head mounted display.

Also, an aspect of the present invention for achieving the above objects is a method of garbling a real-world image for a direct encoding type see-through head mounted display, including steps of: capturing a real-world image through a see-through camera in accordance with a MIPI CSI standard; direct-encoding the captured real-world image into a MIPI DSI format compatible with the see-through head mounted display; and driving the see-through head mounted display to display the real-world image direct-encoded into the MIPI DSI format. The step of direct-encoding the captured real-world image into a MIPI DSI format includes steps of: changing reality of the real-world image by garbling the captured real-world image; and direct-encoding the garbled real-world image. The step of changing reality of the real-world image includes steps of: determining a garbling applied to the real-world image; and garbling the real-world image on the basis of the determined garbling. The step of determining a garbling includes at least one of: determining the garbling on the basis of a command received from a user; determining a psychological state of the user on the basis of a sensor signal obtained from a sensor that observes a physical state of the user and determining the garbling on the basis of the determined psychological state; and determining the user's behavior on the basis of a sensor signal obtained from a sensor that observes the user's behavior and determining the garbling on the basis of the determined behavior. The sensor that observes the user's physical state includes a sensor for detecting a physiological signal of the user including at least one of skin color, pulse rate, blood pressure, electrocardiogram, skin conductivity, electromyogram, and perspiration, and the sensor that observes the user's behavior includes at least one of a position sensor, a GPS sensor, a speed sensor, and an acceleration sensor. The step of garbling the real-world image includes at least one of: changing a pixel value of the real-world image; performing cartoon rendering that applies a 3D image technique to the real-world image to give a feeling like a cartoon; changing a contrast of the real-world image; binarizing the real-world image to perform black and white image processing; changing an expression of a specific object included in the real-world image; adjusting brightness or darkness of the real-world image; and changing at least one of frequency, amplitude, and pitch of sound collected with the real-world image.

Also, an aspect of the present invention for achieving the above objects is a direct encoding type see-through head mounted display having a real-world image garbling function, including: a see-through camera which captures a real-world image in accordance with MIPI CSI standard; a direct encoder which direct-encodes the captured real-world image into a MIPI DSI format compatible with the see-through head mounted display; and a head mounted display which displays the real-world image direct-encoded into the MIPI DSI format. The direct-encoder includes a CSI reality changing unit which changes reality of the real-world image by garbling the captured real-world image and the direct-encoder is configured to direct-encode the garbled real-world image. The CSI reality changing unit includes: a garbling control unit which determines a garbling applied to the real-world image; and an CSI image garbling unit which garbles the real-world image on the basis of the determined garbling. The garbling control unit is configured to perform at least one of: determining the garbling on the basis of a command received from a user; determining a psychological state of the user on the basis of a sensor signal obtained from a sensor that observes a physical state of the user and determining the garbling on the basis of the determined psychological state; and determining the user's behavior on the basis of a sensor signal obtained from a sensor that observes the user's behavior and determining the garbling on the basis of the determined behavior. The sensor that observes the user's physical state includes a sensor for detecting a physiological signal of the user including at least one of skin color, pulse rate, blood pressure, electrocardiogram, skin conductivity, electromyogram, and perspiration, and the sensor that observes the user's behavior includes at least one of a position sensor, a GPS sensor, a speed sensor, and an acceleration sensor. The CSI image garbling unit is configured to perform at least one of: changing a pixel value of the real-world image; performing cartoon rendering that applies a 3D image technique to the real-world image to give a feeling like a cartoon; changing a contrast of the real-world image; binarizing the real-world image to perform black and white image processing; changing an expression of a specific object included in the real-world image; adjusting brightness or darkness of the real-world image; and changing at least one of frequency, amplitude, and pitch of sound collected with the real-world image.

According to the present invention, a method of garbling a real-world image for a see-through head mounted display and a direct encoding type see-through head mounted display, which is distinguished from existing augmented reality techniques for matching virtual information to a real-world image and is distinguished from correction techniques for improving image quality of a see-through image, is provided.

Also, according to the present invention, a see-through head mounted display and a direct encoding type see-through head mounted display that have a real-world image garbling function, in which a reality changing unit is incorporated in a see-through HMD so that effects such as psychotherapy and psychological stability of a user can be provided, are provided.

Also, according to the present invention, since the image captured by the camera is directly converted into the MIPI DSI signal by the direct encoder, a delay for image processing is minimized.

### BRIEF DESCRIPTION OF THE DRAWINGS

FIG. 1 is a diagram illustrating an operating environment of a standalone type seed-through head mounted display without a connection line with an external device.

FIG. 2a is a flowchart schematically illustrating a method of garbling a real-world image for a see-through head mounted display according to an aspect of the present invention, and FIG. 2b is a flowchart schematically illustrating a method of garbling a real-world image for a direct encoding type see-through head mounted display according to an aspect of the present invention.

FIG. 3 is a block diagram schematically illustrating a process of converting a MIPI CSI format into a MIPI DSI format.

FIG. 4a is a block diagram schematically illustrating a see-through head mounted display having a real-world image garbling function according to an aspect of the present invention, and FIG. 4b is a block diagram schematically illustrating a direct encoding type see-through head mounted display having a real-world image garbling function according to an aspect of the present invention.

FIG. 5 is a block diagram schematically illustrating a configuration of an acoustic garbling module that may be embedded in the see-through HMD of FIG. 4.

FIG. 6 is a block diagram schematically illustrating a garbling control unit of FIG. 5.

FIG. 7 is a diagram illustrating results of garbling the real-world according to the present invention.

FIG. 8 is a diagram illustrating an operating environment of a standalone type of a see-through HMD and a direct encoding type seed-through HMD according to the present invention.

### DETAILED DESCRIPTION OF THE INVENTION

The following detailed description of the present invention will refer to the accompanying drawings that show, by way of illustration, specific embodiments in which the present invention may be practiced. These embodiments are described in sufficient detail to enable those skilled in the art to practice the present invention. It should be understood that various embodiments of the present invention are different from each other but need not be mutually exclusive. For example, certain shapes, structures, and characteristics of one embodiment described herein may be modified in other embodiments without departing from the spirit and scope of the present invention. In addition, it should be understood that a location or an arrangement of individual components in each embodiment disclosed herein may be changed without departing from the spirit and scope of the present invention. Therefore, the following detailed description should not be taken in a limiting sense, and the scope of the present invention, if properly described, is defined only by the appended claims, along with the full scope of equivalents to which the claims are entitled. Similar reference numerals in the drawings refer to the same or similar functions throughout various aspects. Further, in order to clearly describe the present invention, parts irrelevant to the description will be omitted, and the same reference numerals in the drawings indicate the same members.

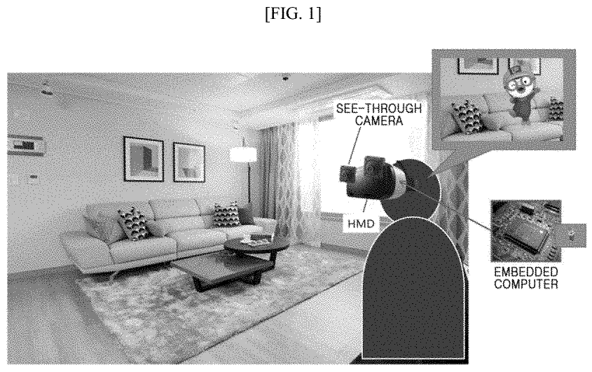

FIG. 1 is a diagram illustrating an operating environment of a standalone type seed-through head mounted display without a connection line with an external device.

The see-through head mounted display (hereinafter also referred to as “see-through HMD”) includes an external device-linked type see-through HMD and a standalone type see-through HMD.

The external device-linked type see-through HMD is an HMD in which image processing is performed by an external device such as an external computer. A see-through camera converts a real-world image in front into a video signal and outputs it to a digital converting unit. Such a video signal is generally a signal conforming to a mobile industry processor interface (MIPI) camera serial interface (CSI) standard. The digital converting unit converts a MIPI CSI standard signal received from the see-through camera into a standard video signal. In the present specification, the standard video signal encompasses signals according to all video signal standards except for the MIPI CSI standard, such as national television system committee (NTSC) and phase alternation by line (PAL) standards for common display devices such as cathode-ray tube (CRT) and liquid crystal display (LCD) monitors, a high definition multimedia interface (HDMI) standard for digital video signals, moving picture experts group (MPEG) and H.264 standards that are compression standards, etc. The converted signal is transmitted to the external device.

The reason why the digital converting unit is required is that a computer typically requires information converted into standard video signals to perform image processing. In the case of an external device-linked HMD, these standard video signals are processed by an external computer device, and, in the case of a standalone type HMD, they are processed by an embedded computer.

Image information processed by the external device is sent back to the HMD. Routes through which the image information is sent can be both wired and wireless. Then, the sent image information is converted by a display driving unit to a MIPI display serial interface (DSI) standard signal. The converted signal is shown to a user via the HMD which is usually an LCD display or an organic light-emitting diode (OLED) display.

In the present specification, the term “image processing” indicates a process such as real-world-virtual world coordinate matching, image rendering, and the like for generating an augmented reality image. For example, image processing includes mixing a see-through image of the real-world with a specific object in virtual reality.

On the other hand, in a standalone type see-through HMD, an embedded computer performs an image modulation process to achieve a desired function. The modulated image is then converted to a MIPI DSI signal via a display driving unit, which is shown to a user via the HMD. A difference between an external device-linked type see-through HMD and a standalone type see-through HMD is that a computer device that receives a standard video signal and processes an image through predetermined information processing is embedded in the standalone type see-through HMD. In this case, since the HMD can operate independently without an external computer device, there is no need for a wired or wireless connection, and thus there is no restriction on motions and movement of a user.

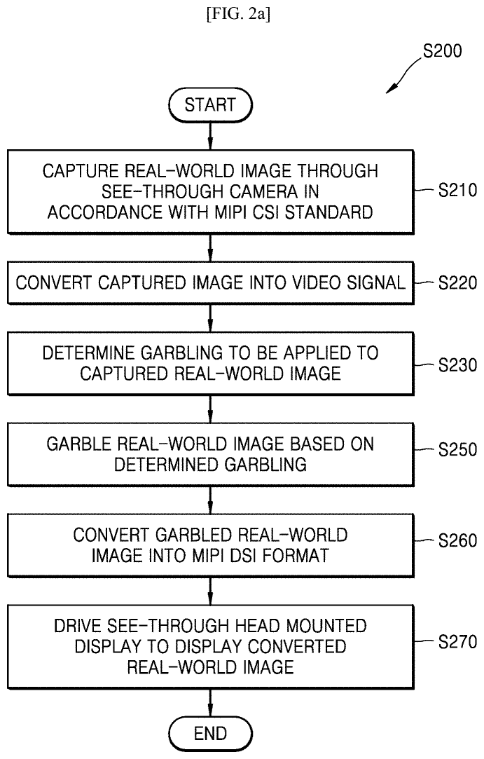

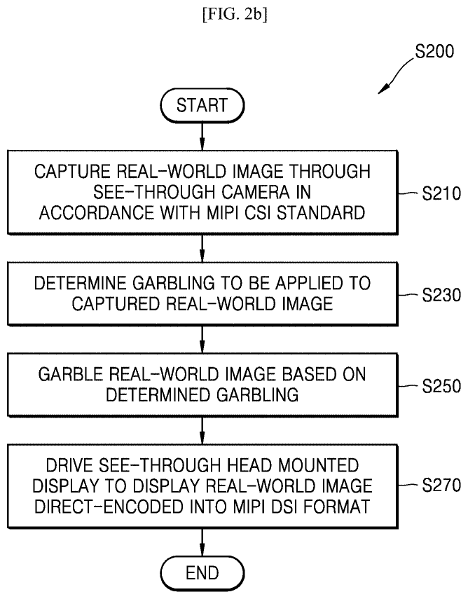

FIG. 2a is a flowchart schematically illustrating a method of garbling a real-world image S200 for a see-through HMD according to an aspect of the present invention, and FIG. 2b is a flowchart schematically illustrating a method of garbling a real-world image S200 for a direct encoding type see-through HMD according to an aspect of the present invention.

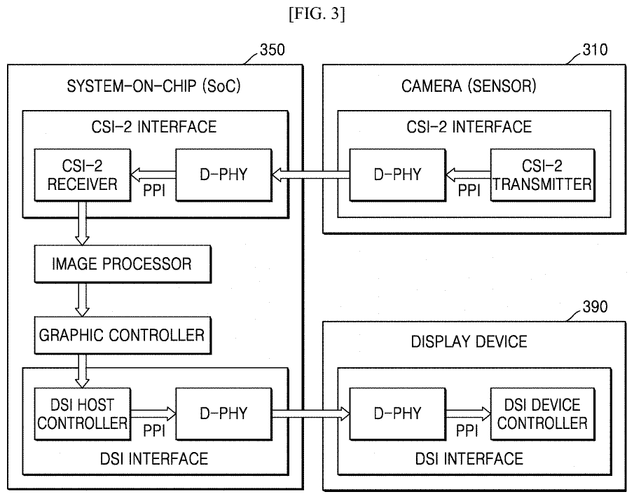

Referring to FIGS. 2a and 2b, first, a rear-world image is captured through a see-through camera according to the MIPI CSI (S210). The MIPI CSI format will be described later in detail with reference to FIG. 3. Therefore, repeated descriptions thereof will be omitted for simplicity of the specification.

When the rear-world image is captured, the captured rear-world image is converted into a video signal (S220). In this case, the converted video signal may be converted into various formats known in the art such as NTSC, PAL, RGB, YCbCr, HDMI, MPEG, AVI, VOB, H.264, and the like. When the rear-world image is converted into the video signal, it can be processed by various image processing devices. In the method of garbling a real-world image for a see-through HMD S200, the real-world image converted into the video signal is garbled to change reality of the real-world image. In the case of the direct encoding type, the converting step can be omitted.

In order to change the reality, first, a garbling to be applied to the rear-world image is determined (S230). The term “garbling” in the present specification indicates changing a rear-world image displayed to a user by applying a variety of processing to the rear-world image.

The following techniques can be used to determine the garbling. It should be noted that these are merely examples for convenience of understanding and do not limit the present invention.

1. The garbling is determined on the basis of a command received from a user. In this case, there is an advantage that the user can directly determine the garbling which is suitable for him or her.

2. An operator other than the user may determine the garbling using a remote control unit. The operator can be a doctor or a psychological counselor who heals a patient. In this case, a treatment effect may be maximized by garbling the rear-world image in accordance with a state of the patient.

3. A psychological state of the user may be determined on the basis of a sensor signal obtained from a sensor that observes a physical state of the user, and the garbling may be determined on the basis of the determined psychological state. The sensor that observes the user's physical state includes a camera that can detect skin color, pulse rate, blood pressure, electrocardiogram, skin conductivity, electromyogram, and perspiration, and various biometric sensors. In this case, the physical state of the user may be directly determined and the rear-world image may be garbled to suit the determined physical state.

4. The user's behavior may be determined on the basis of a sensor signal obtained from a sensor that observes the user's behavior, and the garbling may be determined on the basis of the determined behavior. The sensor that observes the user's behavior may be a position sensor, a global positioning system (GPS) sensor, a speed sensor, an acceleration sensor, or the like. In this case, the user's motions, hyperactivity, decreased activity and the like can be detected and the real-world image can be properly garbled in accordance with a state of each behavior.

When the garbling is determined, the rear-world image is garbled on the basis of the determined garbling (S250). Garbling is applicable to the real-world image in the present invention include the following. It should be noted that these are merely examples for convenience of understanding and do not limit the present invention.

1. Pixel values of the rear-world image may be changed.

For example, it may be undesirable to expose a violent scene to people with anxiety. Therefore, pixel values of parts of the real-world image in which fatigue is felt may be changed and exposed to the user.

2. A 3D image technique can be applied to the real-world image to give a cartoon-like feeling. This technique is called cartoon rendering, and it can have a dreamy effect and provides an effect of reducing tensions in reality because it makes the reality feel like a space in a cartoon.

3. A contrast of the rear-world image may be changed. In general, when the contrast increases, a presented real-world video becomes sharper to make people sensitive. Thus, by adjusting the contrast on the basis of the psychological state of the user, the user may be encouraged to relax the tension felt from reality.

4. If necessary, the rear-world image can be binarized and subjected to black and white image processing. In this case, a gray scale processing can be performed by adjusting steps of the black and white image processing. In extreme tense states, providing black and white images of the real-world image may help the user's emotional stability.

5. An expression of a specific object included in the rear-world image may be changed. For example, traffic indication facilities such as center lines or traffic lights can be very meaningful for a driving user in themselves. In this case, the user's attention can be recalled by highlighting or enlarging and displaying the traffic indication facilities in the rear-world image.

6. Brightness or darkness of the rear-world image may be adjusted. For a user looking at a ski resort or a white sand beach, lowering the brightness of the real-world image can help prevent vision damage, and, for a user in dark environments, visibility can be also improved by increasing brightness.

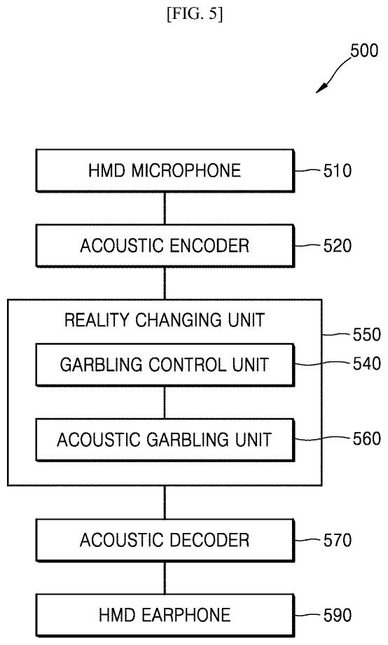

7. At least one of frequency, amplitude, and pitch of sound collected with the rear-world image may be also changed. For a user in a library, background noise can be eliminated to improve the user's concentration, and, for a user exposed to a high noise environment such as a baseball field, an amplitude of the provided sound can be also reduced to protect the user's hearing. A technique for garbling sound will be described later in detail with reference to FIG. 5. Therefore, repeated descriptions thereof will be omitted for simplicity of the specification.

When the rear-world image is garbled, the garbled rear-world image is converted into a MIPI DSI format compatible with the see-through HMD (S260). This conversion is for converting a video signal processed by an image processing device into a signal that can be processed by the see-through HMD.

When the format is converted, the see-through HMD is driven to display the garbled rear-world image (S270). Accordingly, the user gets to watch a scene in which the rear-world image is converted.

Referring to FIG. 2b, in the case of the direct encoding type, the see-through HMD is driven to display the garbled real world image direct-encoded into the MIPI DSI format (S270). According to the method of FIG. 2b, processes in which the captured real-world image is converted into a video format, such as NTSC, PAL, RGB, YCbCr, HDMI, MPEG, AVI, VOB, and H.264, to be subjected to processing, and then converted to a MIPI DSI format, are omitted. Instead, the captured real-world image is direct-encoded into a MIPI DSI format. Therefore, a delay incurred in converting the video signal is minimized.

In more detail, the see-through image basically need to be shown to the user in real time. If there is a delay in outputting the see-through image, the user may be disturbed by activities in the real-world and feel dizzy, strange, or the like. Furthermore, small delays can lead to big accidents while traveling at high speeds. In order to solve this problem, the method of garbling a real-world image for a direct encoding type see-through head HMD according to the present invention directly converts and outputs the MIPI CSI signal of the camera into a MIPI DSI signal. This minimizes the delay in outputting the see-through image.

FIG. 3 is a block diagram schematically illustrating a process of converting the MIPI CSI format into the MIPI DSI format.

As mobile devices such as smartphones have become widespread, a MIPI format has been introduced, especially to meet the constraints of low current consumption and high speed. The MIPI format refers to an interface protocol required for connections between components in mobile devices, and it was initially used between camera sensors and application processors (APs), which are mobile processors, but is now being extended to mobile display devices, storage devices, and Wi-Fi modules.

In the MIPI format, components are connected to each other via a central AP, and CSI and DSI are formats for connecting these components. Signal transmission using the MIPI is achieved through a differential pairing method with a differential amplifier, called low-voltage differential signaling (LVDS). D-PHY and M-PHY are physical layers for implementing the differential pairing method responsible for the signal transmission. Among them, D-PHY is used for cameras and displays, and M-PHY is used for a low-power and high-speed communication.

In FIG. 3, a signal captured by a camera 310 is transmitted to a display device 390 via a SoC 350. The signal captured by the camera 310 is transmitted to the SoC 350 via a CSI-2 transmitter through the D-PHY. The transmitted signal is received by a CSI-2 receiver and passed to an image processor. Then, it is provided to a DSI host controller via a graphics controller. This video signal is also passed to a DSI device controller through the D-PHY. As can be seen in FIG. 3, the signal obtained by the camera 310 is provided to the SoC 350 via the CSI interface, and the SoC 350 sends a signal to display a device 390 through the DSI interface.

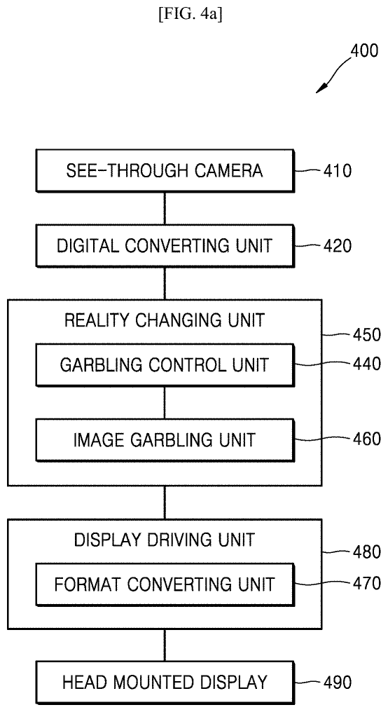

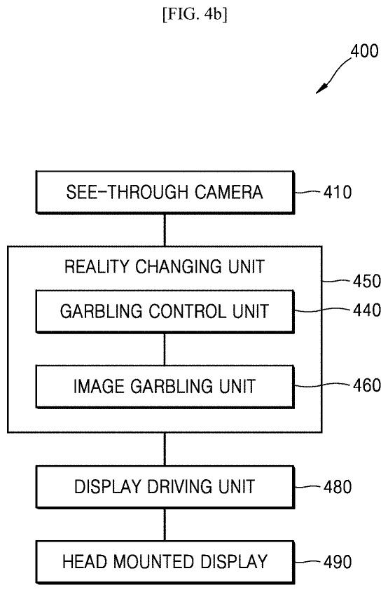

FIG. 4a is a block diagram schematically illustrating a see-through HMD having a real-world image garbling function according to an aspect of the present invention.

Referring to FIG. 4a, a see-through HMD 400 according to the present invention includes a see-through camera 410, a digital converting unit 420, a reality changing unit 450, a display driving unit 480, and a head mounted display 490. In addition, the reality changing unit 450 includes a garbling control unit 440 and an image garbling unit 460, and the display driving unit 480 includes a format converting unit 470.

The see-through camera 410 captures a real-world image and provides it to the digital converting unit 420. Then, the digital converting unit 420 converts the captured real-world image into a video signal and provides it to the reality changing unit 450.

The reality changing unit 450 serves to change reality of the rear-world image by garbling the rear-world image converted into the video signal. To this end, the garbling control unit 440 determines a garbling to be applied to the rear-world image. The process of determining the garbling is as described above with reference to FIG. 2. Therefore, for the sake of simplicity of the specification, repeated descriptions thereof will be omitted.

When the garbling to be applied is determined, the image garbling unit 460 garbles the rear-world image on the basis of the determined garbling. Since the garbling to be applied is also as described above using FIG. 2, repeated descriptions thereof will be omitted for simplicity of the specification.

When the rear-world image is garbled, the format converting unit 470 receives the garbled rear-world image, and converts the received real-world image into a MIPI DSI format compatible with a see-through HMD. Then, the display driving unit 480 receives the garbled rear-world image, and drives the head mounted display 490 to display the received garbled rear-world image.

Therefore, since the HMD 400 according to the present invention includes the separate garbling control unit 440 to control the image garbling, it provides a variety of mental and psychological benefits by providing the image garbling that meets a user's needs in real time to change the reality.

FIG. 4b is a block diagram schematically illustrating a direct encoding type see-through HMD having a real-world image garbling function according to an aspect of the present invention.

Referring to FIG. 4b, a direct encoding type see-through HMD 400 according to the present invention includes a see-through camera 410, a CSI reality changing unit 450, a display driving unit 480, and a head mounted display 490. In addition, the CSI reality changing unit 450 includes a garbling control unit 440 and a CSI image garbling unit 460.

The MIPI CSI signal captured by the see-through camera 410 is transferred to the CSI reality changing unit 450 in the MIPI CSI format without being converted into a video signal. Then, the CSI reality changing unit 450 serves to change the reality of the real world image by garbling the real-world image in the MIPI CSI format. To this end, the garbling control unit 440 determines the garbling to be applied to the rear-world image. The process of determining the garbling is as described above with reference to FIG. 2. Therefore, for the sake of simplicity of the specification, repeated descriptions thereof will be omitted.

When the garbling to be applied is determined, the CSI image garbling unit 460 garbles the rear-world image in the MIPI CSI format on the basis of the determined garbling. Since the garbling to be applied is also as described above using FIG. 2, repeated descriptions thereof will be omitted for simplicity of the specification.

When the real world-image is garbled, the garbled real-world image is provided to the display driving unit 480. Then, the display driving unit 480 drives the head mounted display 490 to display the garbled real-world image.

The CSI reality changing unit is an example of a direct encoder configured to direct-encode the captured real-world image into the MIPI DSI format compatible with the see-through HMD. The CSI reality changing unit 450 is characterized by processing the MIPI CSI signal rather than a standard video signal. In addition, the CSI image garbling unit 460 also directly processes the MIPI CSI signal rather than the standard video signal. The CSI image garbling unit 460 receives a MIPI CSI raw signal, converts it to a video signal in accordance with predetermined garbling rules, and directly outputs it as a MIPI DSI signal. Accordingly, the CSI reality changing unit 450 is directly connected to the see-through camera 410 and the display driving unit 480. To describe in more detail the meaning of the “direct connection,” the CSI image garbling unit is directly connected to a CSI standard output unit for outputting a signal of the camera to receive the signal, and is directly connected to a DSI standard input unit of a display panel to output the signal. As a result, a delay time required for the video signal generated by the camera to reach the display is minimized, so that the user can watch the see-through image without a video delay.

In this process, partial standard video image information may be further generated and used for processing some information. However, this can be done with multi-threaded information processing that does not affect the video delay. However, the direct encoding type see-through HMD is characterized in that the standard video image information is not essential information for implementing the present invention.

Since the direct encoding type HMD 400 according to the present invention includes the separate garbling control unit 440 to control the image garbling while minimizing the video delay, it provides a variety of mental and psychological benefits by providing the image garbling that meets a user's needs in real time to change the reality.

FIG. 5 is a block diagram schematically illustrating a configuration of an acoustic garbling module 500 that may be embedded in the see-through HMD of FIG. 4.

The acoustic garbling module 500 includes an HMD microphone 510, an acoustic encoder 520, a reality changing unit 550, an acoustic decoder 570, and an HMD earphone 590. In addition, the reality changing unit 550 includes a garbling control unit 540 and an acoustic garbling unit 560.

The HMD microphone 510 collects rear-world sound and provides it to the acoustic encoder 520. Then, the acoustic encoder 520 converts the collected sound into an acoustic signal and provides it to the reality changing unit 550.

The reality changing unit 550 plays a role of garbling the rear-world sound converted into the acoustic signal to change reality. To this end, the garbling control unit 540 determines the garbling to be applied to the rear-world sound. A process of determining the garbling is as described above with reference to FIG. 2. Therefore, repeated descriptions thereof will be omitted for simplicity of the specification.

When the garbling to be applied is determined, the acoustic garbling unit 560 garbles the rear-world sound on the basis of the determined garbling. Pitch, frequency, amplitude, and the like of the sound may be garbled. In addition, examples of acoustic garbling may include inducing a user's attention by removing or amplifying specific frequencies, adding spatial effects such as echo and reverb, or adding specific acoustic components. However, this is not a limitation of the present invention, and the present invention may adopt any sound processing technique known in the art. The acoustic garbling may be provided simultaneously with the image garbling, or both may be provided separately.

When the rear-world sound is garbled, the acoustic decoder 570 receives the garbled rear-world sound and decodes the received rear-world sound to be reproduced by the HMD earphone 590.

Therefore, since the acoustic garbling module 500 according to the present invention includes the separate garbling control unit 540 to control the acoustic garbling, it provides a variety of mental and psychological benefits by providing the acoustic garbling that meets a user's needs in real time to change the reality.

Although the acoustic garbling module 500 of FIG. 5 is illustrated as a separate module, it may be embedded in the see-through HMD 400 of FIG. 4.

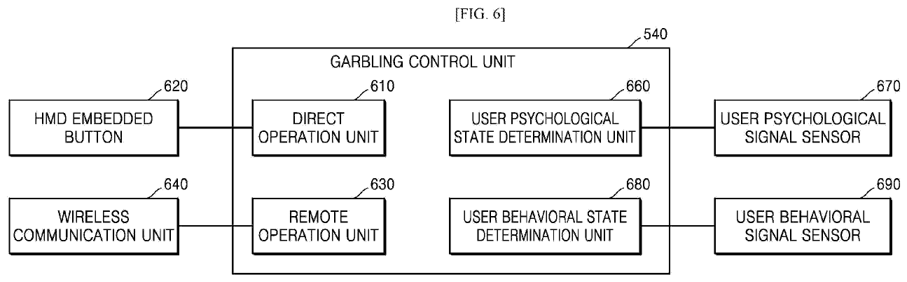

FIG. 6 is a block diagram schematically illustrating the garbling control unit of FIG. 5.

The garbling control unit 540 includes a direct operation unit 610, a remote operation unit 630, a user psychological state determination unit 660, and a user behavioral state determination unit 680. In addition, the direct operation unit 610, the remote operation unit 630, the user psychological state determination unit 660, and the user behavioral state determination unit 680 are connected respectively to an HMD built-in button 620, a wireless communication unit 640, a user psychological signal sensor 670, and user behavioral signal sensor 690.

The direct operation unit 610 and the remote operation unit 630 receive a signal for controlling garbling through the HMD built-in button 620 and the wireless communication unit 640, respectively. Such a signal may be provided directly by the user or by a third party other than the user.

The direct operation unit 610 transmits a signal such as on/off of image garbling, switching of garbling rules, and the like to the image garbling unit (acoustic garbling unit).

The user psychological state determination unit 660 diagnoses a psychological state of a user on the basis of the signal received from the sensor unit. For example, if a pulse rate of the user surges, it diagnoses that the user is in a tension and stress situation and calculates a tension state value. Then, the user psychological state determination unit 660 determines an image (acoustic) garbling method corresponding to the calculated tension state and transmits it to the image garbling unit (acoustic garbling unit).

The psychological signal sensor 670 collects various biological signals of the user in order to generate a signal about the psychological state of the user. In the present specification, the biological signal indicates an electrical signal which is measured from a human body and has energy or information about the human body. The human body generates electricity as a conductor, and an electrical value thereof changes in accordance with human metabolism and physical state. In particular, since information is transmitted via voltage fluctuations on surfaces of nerves or muscle cells, various information can be obtained by monitoring the information. In addition, information may be transmitted through body fluids to a body surface, that is, skin.

Such sensors may include an electrocardiogram (ECG) sensor, an electroencephalogram (EGE) sensor, an electroneuronography (ENG) sensor, an electromyogram (EMG) sensor, an electroretinogram (ERG) sensor, an electrogastrography (EGG) sensor, an electrooculography (EOG) sensor, or the like. However, it should be noted that the present invention is not limited thereto, and various sensors known in the art can be applied to the present invention. For example, a camera for detecting skin color, a pulse wave sensor, a blood pressure sensor, a perspiration sensor, or the like may also be applied to the present invention.

The behavioral state detected by the user behavioral state determination unit 680 includes all the behaviors that can be determined to be related to the psychological state, such as long pauses, sitting, waking up, running, severe head movements, and screaming. The user behavioral state determination unit 680 diagnoses the psychological state corresponding to the signal received from the sensor unit. For example, when the user is stationary without movement for a long time, it is diagnosed as an attention state and calculates an attention state value thereof. Then, the user behavioral state determination unit 680 determines an image (acoustic) garbling method corresponding to the calculated attention state value, and transmits it to the image garbling unit (acoustic garbling unit). For example, in the attention state, in order to reduce the attention of the user, the image garbling unit performs binarization of the image and lowers the binarization threshold value so that the image becomes dark overall. In this case, it may be an embodiment of the present invention to restore the seed-through image to its original state at the moment when the user stops excessive attention and looks around.

A position sensor, a GPS sensor, a speed sensor, an acceleration sensor, and the like may be utilized for the user behavioral signal sensor 690. For example, when a movement acceleration of a head of a user on which the HMD is put is large, it may be determined that the user is in an anxious state.

The remote operation unit 630 remotely provides an image (acoustic) garbling that is determined to be most suitable for the user at the present when an outsider who observes the user observes the user's behaviors. The outsider transmits an image (acoustic) garbling change signal to the wireless communication unit 640 embedded in the HMD using a remote control device during observing the user. The change signal received by the wireless communication unit is transmitted to the remote operation unit 630, and the remote operation unit transmits the image (acoustic) garbling rule corresponding to this signal to the image garbling unit (acoustic garbling unit), thereby causing the garbling rule to change. For example, a therapist who determines that a patient needs to calm down excessive excitement presses a button corresponding to a relaxing function of a remote control device possessed by him or her. At this time, the remote operation unit 630 transmits a corresponding wireless signal to the wireless communication unit 640 embedded in the HMD. The remote operation unit 630 transmits a command to operate a cartoon rendering garbling and a garbling for changing a phase of sound corresponding to the received signal to the image garbling unit (acoustic garbling unit), and the image garbling unit (acoustic garbling unit) immediately changes the garbling rule to display the image (output the sound). This allows the user to experience changed visual (hearing) information. The remote operation unit can also be controlled by the user himself.

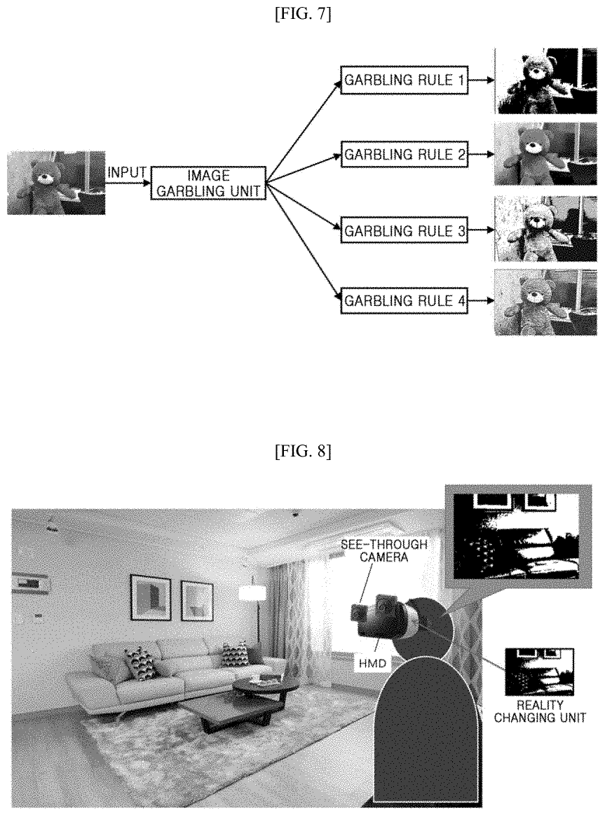

FIG. 7 is a diagram illustrating results of garbling the rear-world image according to the present invention.

Garbling Rule 1 is a typical simple binarization rule. The binarization is a conversion rule that replaces all pixel values with 0 or 1 and outputs black for 0 and white for 1. At this time, when a threshold value is lowered, most pixel values become 0 and become dark. Image garbling also includes such adjustment of parameter values. Garbling Rule 2 is cartoon rendering. The cartoon rendering is a technique to create a painting effect by unifying adjacent pixel values of similar color into one identical value. This also changes result values depending on various parameter values. Garbling rules 3 and 4 are examples of images output by complex image garbling rules. One or more of these garbling rules may be used in combination. In addition, these garbling rules are for convenience of description only and do not limit the present invention. Therefore, repeated descriptions thereof will be omitted for simplicity of the specification.

The garbling of the real-world image is selected and provided on the basis of psychological states of a user so that psychological stability of the user can be achieved.

FIG. 8 is a diagram illustrating an operating environment of a standalone type acoustic garbling module according to the present invention.

As illustrated in FIG. 8, the real-world image is subjected to black and white image processing performed by the reality changing unit and provided to the HMD. Thus, a tension state of the user can be alleviated.

The present invention can be utilized to induce attention of autism patients by emphasizing or removing certain objects in the see-through image in accordance with predetermined garbling rules. In addition, by garbling the see-through image in a direction lowering the reality in accordance with predetermined garbling rules, phobia thereof can be alleviated. Furthermore, by providing the image garbled in accordance with predetermined garbling rules, it is possible to prevent panic disorder or to reduce psychological burden at the time of seizures, and by providing the image garbled in accordance with predetermined garbling rules, depression and mood swings can be prevented or symptoms thereof can be alleviated. Also, according to the present invention, by providing the image garbled in accordance with predetermined garbling rules, it is possible to prevent symptoms such as delusions, and auditory or visual hallucinations, or to reduce psychological burdens at the time of seizures, and by providing the image garbled in accordance with predetermined garbling rules, it can be utilized in stepped desensitization treatment to alleviate symptoms of fear.

It should be understood that the present invention has been described with reference to the embodiment shown in the drawings, but this is merely illustrative and various modifications and other equivalent embodiments can be made by those skilled in the art from the embodiment.

In addition, the method according to the present invention can be embodied as computer readable codes on a computer readable recording medium. The computer readable recording medium may include all kinds of recording devices in which data that can be read by a computer system is stored. Examples of computer-readable recording media include ROM, RAM, CD-ROM, magnetic tapes, floppy disks, optical data storage devices, and the like, and also include those implemented in the form of carrier waves (for example, transmission over the Internet). Also, the computer readable recording medium can store computer readable codes that can be executed in a distributed fashion by a distributed computer system connected through a network.

It should be understood that singular forms of terms as used herein include plural forms unless the context clearly dictates otherwise. It should also be understood that the terms “include,” “comprise,” and the like mean that the described features, numbers, steps, operations, components, parts or combinations thereof exist, and a possibility of presence or addition of one or more other features, numbers, steps, operations, components, parts or combinations thereof are not excluded. In addition, the terms “ . . . part,” “ . . . group,” “module,” “block,” etc., described in the specification mean a unit for processing at least one function or operation, which may be implemented in hardware or software or a combination thereof.

Therefore, it should be apparent that the exemplary embodiments and the drawings attached to the present specification only clearly show some of the technical ideas included in the present invention, and modifications and specific embodiments that can be easily inferred by those skilled in the art within the scope of the technical spirit included in the specification and drawings of the present invention are included in the scope of the present invention.

The present invention can be applied to a see-through HMD.

### EXPLANATION OF REFERENCES

400 See-through HMD
410 See-through camera
420 Digital converting unit
440 Garbling control unit
450 Reality changing unit, CSI reality changing unit
460 Image garbling unit, CSI image garbling unit
470 Format converting unit
480 Display driving unit
490 Head mounted display

What is claimed is:

1. A method of garbling a real-world image for a see-through head mounted display, comprising steps of:
capturing a real-world image through a see-through camera;
converting the captured real-world image into a video signal;
changing reality of the real-world image by garbling the real-world image converted into the video signal; and
receiving the garbled real-world image and driving the see-through head mounted display to display the received garbled real-world image.

2. The method of garbling a real-world image for a see-through head mounted display according to claim 1,
wherein the step of capturing the real-world image includes a step of capturing the real-world image in accordance with a mobile industry processor interface (MIPI) camera serial interface (CSI) standard, and
the step of converting the captured real-world image into a video signal includes a step of converting the MIPI CSI signal into a format selected from the group consisting of NTSC, PAL, RGB, YCbCr, HDMI, MPEG, AVI, VOB, and H.264.

3. The method of garbling a real-world image for a see-through head mounted display according to claim 2,
wherein the step of changing reality of the real-world image includes steps of:
determining a garbling applied to the real-world image; and
garbling the real-world image on the basis of the determined garbling.

4. The method of garbling a real-world image for a see-through head mounted display according to claim 3,
wherein the step of determining a garbling includes at least one of:
determining the garbling on the basis of a command received from a user;
determining a psychological state of the user on the basis of a sensor signal obtained from a sensor that observes a physical state of the user and determining the garbling on the basis of the determined psychological state; and
determining the user's behavior on the basis of a sensor signal obtained from a sensor that observes the user's behavior and determining the garbling on the basis of the determined behavior.

5. The method of garbling a real-world image for a see-through head mounted display according to claim 4,
wherein the sensor that observes the user's physical state includes a sensor for detecting a physiological signal of the user including at least one of skin color, pulse rate, blood pressure, electrocardiogram, skin conductivity, electromyogram, and perspiration, and
the sensor that observes the user's behavior includes at least one of a position sensor, a GPS sensor, a speed sensor, and an acceleration sensor.

6. The method of garbling a real-world image for a see-through head mounted display according to claim 3,
wherein the step of garbling the real-world image includes at least one of:
changing a pixel value of the real-world image;
performing cartoon rendering that applies a 3D image technique to the real-world image to give a feeling like a cartoon;
changing a contrast of the real-world image;
binarizing the real-world image to perform black and white image processing;
changing an expression of a specific object included in the real-world image;
adjusting brightness or darkness of the real-world image; and
changing at least one of frequency, amplitude, and pitch of sound collected with the real-world image.

7. The method of garbling a real-world image for a see-through head mounted display according to claim 2, wherein the step of driving the see-through head mounted display includes a step of converting the received garbled real-world image into a MIPI display serial interface (DSI) format compatible with the see-through head mounted display and providing the result to a driving unit of the see-through head mounted display.

8. A see-through head mounted display having a real-world image garbling function, comprising:
a see-through camera which captures a real-world image;
a digital converting unit which converts the captured real-world image into a video signal,
a reality changing unit which changes reality of the real-world image by garbling the real-world image converted into the video signal; and
a display driving unit which receives the garbled real-world image and drives the see-through head mounted display to display the received garbled real-world image.

9. The see-through head mounted display having a real-world image garbling function according to claim 8,
wherein the see-through camera captures the real-world image in accordance with a MIPI CSI standard, and
the digital converting unit converts the MIPI CSI signal into a format selected from the group consisting of NTSC, PAL, RGB, YCbCr, HDMI, MPEG, AVI, VOB, and H.264.

10. The see-through head mounted display having a real-world image garbling function according to claim 9,
wherein the reality changing unit includes:
a garbling control unit which determines the garbling applied to the real-world image; and
an image garbling unit which garbles the real-world image on the basis of the determined garbling.

11. The see-through head mounted display having a real-world image garbling function according to claim 10,
wherein the garbling control unit is configured to perform at least one of:
determining the garbling on the basis of a command received from a user;
determining a psychological state of the user on the basis of a sensor signal obtained from a sensor that observes a physical state of the user and determining the garbling on the basis of the determined psychological state; and
determining the user's behavior on the basis of a sensor signal obtained from a sensor that observes the user's behavior and determining the garbling on the basis of the determined behavior.

12. The see-through head mounted display having a real-world image garbling function according to claim 11,
wherein the sensor that observes the user's physical state includes a sensor for detecting a physiological signal of the user including at least one of skin color, pulse rate, blood pressure, electrocardiogram, skin conductivity, electromyogram, and perspiration, and
the sensor that observes the user's behavior includes at least one of a position sensor, a GPS sensor, a speed sensor, and an acceleration sensor.

13. The see-through head mounted display having a real-world image garbling function according to claim 10,
wherein the image garbling unit is configured to perform at least one of:
changing a pixel value of the real-world image;
performing cartoon rendering that applies a 3D image technique to the real-world image to give a feeling like a cartoon;
changing a contrast of the real-world image;
binarizing the real-world image to perform black and white image processing;
changing an expression of a specific object included in the real-world image;
adjusting brightness or darkness of the real-world image; and
changing at least one of frequency, amplitude, and pitch of sound collected with the real-world image.

14. The see-through head mounted display having a real-world image garbling function according to claim 9,
wherein the display driving unit is configured to convert the received garbled real-world image into a MIPI DSI format compatible with the see-through head mounted display to drive the see-through head mounted display.

15. A method of garbling a real-world image for a direct encoding type see-through head mounted display, comprising steps of:
capturing a real-world image through a see-through camera in accordance with a MIPI CSI standard;
direct-encoding the captured real-world image into a MIPI DSI format compatible with the see-through head mounted display; and
driving the see-through head mounted display to display the real-world image direct-encoded into the MIPI DSI format.

16. The method of garbling a real-world image for a direct encoding type see-through head mounted display according to claim 15,
wherein the step of direct-encoding the captured real-world image into a MIPI DSI format includes steps of:
changing reality of the real-world image by garbling the captured real-world image; and
direct-encoding the garbled real-world image.

17. The method of garbling a real-world image for a direct encoding type see-through head mounted display according to claim 16,
wherein the step of changing reality of the real-world image includes steps of:
determining a garbling applied to the real-world image; and
garbling the real-world image on the basis of the determined garbling.

18. The method of garbling a real-world image for a direct encoding type see-through head mounted display according to claim 17,
wherein the step of determining a garbling includes at least one of:
determining the garbling on the basis of a command received from a user;
determining a psychological state of the user on the basis of a sensor signal obtained from a sensor that observes a physical state of the user and determining the garbling on the basis of the determined psychological state; and
determining the user's behavior on the basis of a sensor signal obtained from a sensor that observes the user's behavior and determining the garbling on the basis of the determined behavior.

19. The method of garbling a real-world image for a direct encoding type see-through head mounted display according to claim 18,
wherein the sensor that observes the user's physical state includes a sensor for detecting a physiological signal of the user including at least one of skin color, pulse rate, blood pressure, electrocardiogram, skin conductivity, electromyogram, and perspiration, and
the sensor that observes the user's behavior includes at least one of a position sensor, a GPS sensor, a speed sensor, and an acceleration sensor.

20. The method of garbling a real-world image for a direct encoding type see-through head mounted display according to claim 17,
wherein the step of garbling the real-world image includes at least one of:
changing a pixel value of the real-world image;
performing cartoon rendering that applies a 3D image technique to the real-world image to give a feeling like a cartoon;
changing a contrast of the real-world image;
binarizing the real-world image to perform black and white image processing;
changing an expression of a specific object included in the real-world image;
adjusting brightness or darkness of the real-world image; and
changing at least one of frequency, amplitude, and pitch of sound collected with the real-world image.

21. A direct encoding type see-through head mounted display having a real-world image garbling function, comprising:
a see-through camera which captures a real-world image in accordance with MIPI CSI standard;
a direct encoder which direct-encodes the captured real-world image into a MIPI DSI format compatible with the see-through head mounted display; and
a head mounted display which displays the real-world image direct-encoded into the MIPI DSI format.

22. The direct encoding type see-through head mounted display having a real-world image garbling function according to claim 21,
wherein the direct-encoder includes a CSI reality changing unit which changes reality of the real-world image by garbling the captured real-world image, and
the direct-encoder is configured to direct-encode the garbled real-world image.

23. The direct encoding type see-through head mounted display having a real-world image garbling function according to claim 22,
wherein the CSI reality changing unit includes:
a garbling control unit which determines a garbling applied to the real-world image; and an CSI image garbling unit which garbles the real-world image on the basis of the determined garbling.

24. The direct encoding type see-through head mounted display having a real-world image garbling function according to claim 23,
wherein the garbling control unit is configured to perform at least one of:
determining the garbling on the basis of a command received from a user;
determining a psychological state of the user on the basis of a sensor signal obtained from a sensor that observes a physical state of the user and determining the garbling on the basis of the determined psychological state; and
determining the user's behavior on the basis of a sensor signal obtained from a sensor that observes the user's behavior and determining the garbling on the basis of the determined behavior.

25. The direct encoding type see-through head mounted display having a real-world image garbling function according to claim 24,
wherein the sensor that observes the user's physical state includes a sensor for detecting a physiological signal of the user including at least one of skin color, pulse rate, blood pressure, electrocardiogram, skin conductivity, electromyogram, and perspiration, and
the sensor that observes the user's behavior includes at least one of a position sensor, a GPS sensor, a speed sensor, and an acceleration sensor.

26. The direct encoding type see-through head mounted display having a real-world image garbling function according to 23,
wherein the CSI image garbling unit is configured to perform at least one of:
changing a pixel value of the real-world image;
performing cartoon rendering that applies a 3D image technique to the real-world image to give a feeling like a cartoon;
changing a contrast of the real-world image;
binarizing the real-world image to perform black and white image processing;
changing an expression of a specific object included in the real-world image;
adjusting brightness or darkness of the real-world image; and
changing at least one of frequency, amplitude, and pitch of sound collected with the real-world image.
